(19) United States
(12) Patent Application Publication
(10) Pub. No.: US 2024/0330169 A1
(43) Pub. Date: Oct. 3, 2024

(54) GENERATING REFERENTIAL ARTIFICIAL INTELLIGENCE FUNCTIONALITY FOR INTUITIVELY TAGGING INFRASTRUCTURE

(71) Applicant: INTERNATIONAL BUSINESS MACHINES CORPORATION, ARMONK, NY (US)

(72) Inventors: ANDREW C.M. HICKS, HIGHLAND, NY (US); MICHAEL TERRENCE COHOON, FISHKILL, NY (US); DANIEL NICOLAS GISOLFI, HOPEWELL JUNCTION, NY (US); RYAN THOMAS RAWLINS, NEW PALTZ, NY (US)

(21) Appl. No.: 18/193,690

(22) Filed: Mar. 31, 2023

(51) Int. Cl. G06F 11/36; G06F 40/20

(52) U.S. Cl. CPC G06F 11/3692; G06F 11/3684; G06F 40/20

(57) ABSTRACT

Generating referential artificial intelligence functionality for intuitively tagging infrastructure may include: generating, automatically, a set of tags based on a collection of test cases; tagging a test case with one or more automatically generated tags from the set of tags; running the test case on a system-under-test (SUT); determining that a result of the testing identifies a fault related to a first tag of the one or more automatically generated tags of the test case; and validating an association between the first tag and the test case in response to identifying that the fault is related to the first tag.

### BACKGROUND

### Field of the Disclosure

The field of the disclosure is system testing, or, more specifically, methods, apparatus, and products for generating referential artificial intelligence functionality for intuitively tagging infrastructure.

### Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

System testing in a complex environment can be challenging. When many different components, products, and applications interact across a complex hardware and software stack, a single change can impact the whole system. In order to reduce risk that a change will introduce or expose a problem, testing is performed against the entire stack. This may include unit and function tests to the changed area, as well as system and integration testing performed against the entire environment. In a complex environment with many different pieces, many tests would need to be performed in order to verify that a change does not cause a defect with confidence.

When a component (e.g., a software component or a hardware component) is updated, it may be tested to determine if the update creates errors or bugs in other components of the system that were previously working. These new errors are known as regressions, and thus testing for the errors is referred to as regression testing. This testing may include the design, development, and execution of a number of test cases. Each test case generally includes a number of test conditions, a test script to be executed to test the conditions, and the expected result for each major step in the script. Thousands of test cases may be developed for an application. Executing the entire set test cases developed during system testing can become expensive and time consuming. Accordingly, often not all the test cases are selected for the testing. Typically, for a large and complex system comprising thousands of test cases, the test engineers intuitively select regression tests based on their experience and knowledge on program change specifications that need to be re-executed.

### SUMMARY

Apparatus and systems for generating referential artificial intelligence functionality for intuitively tagging infrastructure according to various embodiments are disclosed in this specification. In a particular embodiment, a method of generating referential artificial intelligence functionality for intuitively tagging infrastructure includes generating, automatically, a set of tags based on a collection of test cases. The method also includes tagging a test case with one or more automatically generated tags from the set of tags. The method also includes running the test case on a system-under-test (SUT). The method also includes determining that a result of the testing identifies a fault related to a first tag of the one or more automatically generated tags of the test case. The method also includes validating an association between the first tag and the test case in response to identifying that the fault is related to the first tag.

The foregoing and other objects, features and advantages of the disclosure will be apparent from the following more particular descriptions of exemplary embodiments of the disclosure as illustrated in the accompanying drawings wherein like reference numbers generally represent like parts of exemplary embodiments of the disclosure.

### BRIEF DESCRIPTION OF THE DRAWINGS

FIG. 1 a block diagram of an example computing system configured for generating referential artificial intelligence functionality for intuitively tagging infrastructure in accordance with embodiments of the present disclosure.

FIG. 2 shows a system for generating referential artificial intelligence functionality for intuitively tagging infrastructure in accordance with embodiments of the present disclosure.

FIG. 3 is a flowchart of an example method for generating referential artificial intelligence functionality for intuitively tagging infrastructure according to some embodiments of the present disclosure.

FIG. 4 is a flowchart of an example method for generating referential artificial intelligence functionality for intuitively tagging infrastructure according to some embodiments of the present disclosure.

FIG. 5 is a flowchart of an example method for generating referential artificial intelligence functionality for intuitively tagging infrastructure according to some embodiments of the present disclosure.

FIG. 6 is a flowchart of an example method for generating referential artificial intelligence functionality for intuitively tagging infrastructure according to some embodiments of the present disclosure.

FIG. 7 is a flowchart of an example method for generating referential artificial intelligence functionality for intuitively tagging infrastructure according to some embodiments of the present disclosure.

### DETAILED DESCRIPTION

As noted above, test engineers often intuitively select regression tests based on their experience and knowledge on program change specifications that need to be re-executed. To facilitate test selection, intelligent automated testing, as disclosed here, may identify a more targeted set of test cases based on labels or “tags” assigned to the test case. A particular test case can be automatically “tagged” as pertaining to a certain function, software component, use case, and so on. Each test case can have one or more tags that describe the type of testing that occurs, and this provides testers with a means of running particular test cases based on what was changed in the development stream. For example, if one part of the operating system called OSPART01 was changed, and this change is related to both networking and file I/O, the tester can find all of the testcases that are tagged with “networking,” “file I/O”, and “ospart01.” The tester knows that these tests are directly applicable to the updated part and are the most testcases relevant to run. In accordance with embodiments of the present disclosure, an automated test tool utilizes self-referential artificial intelligence and a machine learning model to automatically generate tags for test cases and validate those tags based on fault conditions identified by the test cases.

Tags may be classified in one of two sets. One set contains the tags that are known to be true, and this would include tags that developers and test engineers verify and manually contribute to the test case. The second set may contain tags that are discovered. One way to discover tags is with artificial intelligence. A test tool incorporating artificial intelligence (AI) reads in all the test cases, parse the test cases using natural language processing, remove stop words, and tags the test cases based on the tokens that were parsed out. The tagged test cases can also be stored in a database. When the need to perform testing arises, a tester can query the database for all test cases with certain tags. This will provide a list of test cases that matched both the tags provided by humans as well as the tags automatically generated by AI.

It is possible that the initial generated tags do not accurately reflect what the test case actually does or tests. In this case, the machine learning models used may be retrained and the testing tool may recalculate the test case tags. When doing so, the AI may add new tags to a test case or it may remove tags. In the case of tags being removed, this may result in less test cases being ran for a certain tag. However, if the retraining suggests that a tag be removed from a test case but it is known that this test case has discovered a problem related to that tag, the tag may be hardened or promoted instead of removing it. When promoting the tag, it is removed from the set of automatically generated tags and is instead added to the set of tags known to be true. This process ensures that the discovered tags are correct and up-to-date while also augmenting the known truths. This prevents tests that find problems from ceasing to run if the retrained AI wants to remove a tag.

In addition to tagging test cases, information about the changing piece the system may be tagged. Code comments, public documentation, internal data sources, and more can all be consumed by the AI module, which reads in all these sources, parse them using NLP, remove stop words, and tag the documents based on the tokens that were parsed out. If a new piece of code is committed to the development stream, a tester will no longer need to manually identify the tags in order to search for test cases. Instead, new documentation is automatically parsed, tags are identified, a search for test cases with matching test cases is done, and all matching test cases can be performed.

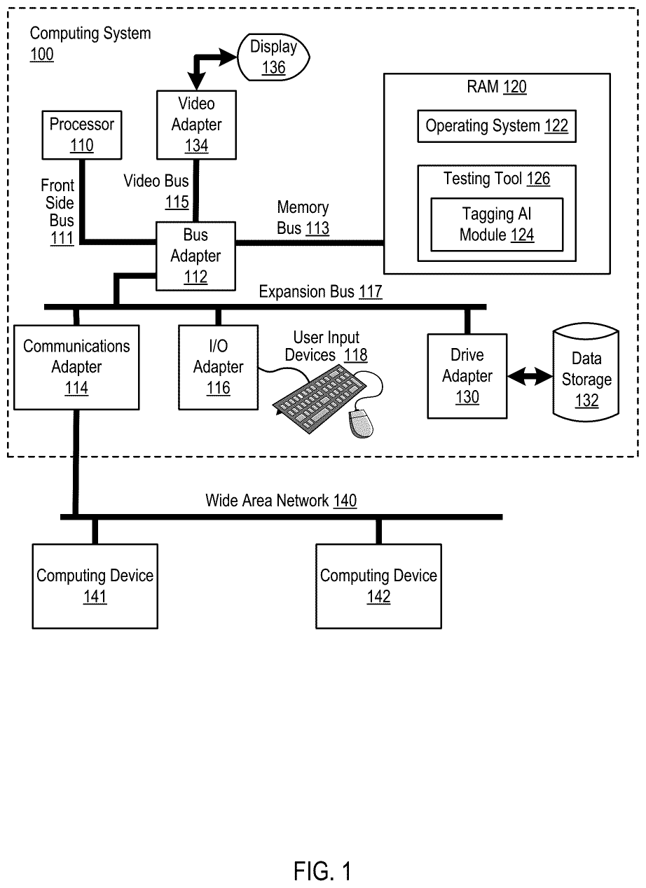

Exemplary apparatus and systems for generating referential artificial intelligence functionality for intuitively tagging infrastructure in accordance with the present disclosure are described with reference to the accompanying drawings, beginning with FIG. 1. FIG. 1 sets forth a block diagram of automated computing machinery comprising an exemplary computing system 100 configured for generating referential artificial intelligence functionality for intuitively tagging infrastructure according to embodiments of the present disclosure. The computing system 100 of FIG. 1 includes at least one computer processor 110 or ‘CPU’ as well as random access memory (‘RAM’) 120 which is connected through a high speed memory bus 113 and bus adapter 112 to processor 110 and to other components of the computing system 100.

Stored in RAM 120 is an operating system 122. Operating systems useful in computers configured for generating referential artificial intelligence functionality for intuitively tagging infrastructure according to embodiments of the present disclosure include UNIX™, Linux™. Microsoft Windows™. AIX™, and others as will occur to those of skill in the art. The operating system 122 in the example of FIG. 1 is shown in RAM 120, but many components of such software typically are stored in non-volatile memory also, such as, for example, on data storage 132, such as a disk drive. Also stored in RAM is a testing tool 126 configured for generating referential artificial intelligence functionality for intuitively tagging infrastructure according to embodiments of the present disclosure. The testing tool 126 is a computer program that facilitates regression testing of software including applications, operating systems, drivers, and so on. The testing tool intelligently identifies a particular set of regression tests from a universe of regression tests and automatically applies the regression tests to a particular code package or codebase. The testing tool 126 includes a tagging artificial intelligence (AI) module 124. The tagging AI module includes machine learning algorithms, natural language processing algorithms, and other types of rules-based predictive algorithms and techniques useful for generating referential artificial intelligence functionality for intuitively tagging infrastructure according to embodiments of the present disclosure. The tagging AI module 124 generates and validates tags that are associated with test cases and used by the testing tool 126 to identify test cases.

In some examples, the testing tool 126 is embodied in a set of processor-executable computer program instructions that, when executed by the processor, configure the computing system 100 to: generate, automatically, a set of tags based on a collection of test cases; tag a test case with one or more automatically generated tags from the set of tags; run the test case on an SUT; determine that a result of the testing identifies a fault related to a first tag of the one or more automatically generated tags of the test case; and validate an association between the first tag and the test case in response to identifying that the fault is related to the first tag. In some examples, the set of tags is automatically generated through a machine-learning natural language processing (ML/NLP) framework. In some examples, the first tag is validated by hardening the first tag for the test case.

The computer program instructions of the testing tool 126 may also configure the computing system 100 to retrain a machine-learning natural language processing (ML/NLP) framework.

The computer program instructions of the testing tool 126 may also configure the computing system 100 to: parse each test case in the collection of test cases; generate a relevancy score for each token parsed from the collection of test cases; and select, based on the relevancy scores, tokens as the set of tags.

The computer program instructions of the testing tool 126 may also configure the computing system 100 to: receive a test case query including search criteria; match the search criteria to the test case based on the one or more automatically generated tags; and populate a regression test bucket with one or more test cases including the test case.

The computer program instructions of the testing tool 126 may also configure the computing system 100 to: identify a corpus of documents related to a system update; generate, automatically, one or more tags for the corpus of documents; match at least one tag of one or more test cases to at least one tag for the corpus of documents; and populate a regression test bucket for the system update with the one or more test cases.

The computing system 100 of FIG. 1 includes disk drive adapter 130 coupled through expansion bus 117 and bus adapter 112 to processor 110 and other components of the computing system 100. Disk drive adapter 130 connects non-volatile data storage to the computing system 100 in the form of data storage 132. Disk drive adapters useful in computers configured for inserting sequence numbers into editable tables according to embodiments of the present disclosure include Integrated Drive Electronics (‘IDE’) adapters, Small Computer System Interface (‘SCSI’) adapters, and others as will occur to those of skill in the art. Non-volatile computer memory also may be implemented for as an optical disk drive, electrically erasable programmable read-only memory (so-called ‘EEPROM’ or ‘Flash’ memory), RAM drives, and so on, as will occur to those of skill in the art.

The example computing system 100 of FIG. 1 includes one or more input/output (′I/O′) adapters 116. I/O adapters implement user-oriented input/output through, for example, software drivers and computer hardware for controlling output to display devices such as computer display screens, as well as user input from user input devices 118 such as keyboards and mice. The example computing system 100 of FIG. 1 includes a video adapter 134, which is an example of an I/O adapter specially designed for graphic output to a display device 136 such as a display screen or computer monitor. Video adapter 134 is connected to processor 110 through a high speed video bus 115, bus adapter 112, and the front side bus 111, which is also a high speed bus.

The exemplary computing system 100 of FIG. 1 includes a communications adapter 114 for data communications with other computers and for data communications with a data communications network. Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful in computers configured for inserting sequence numbers into editable tables according to embodiments of the present disclosure include modems for wired dial-up communications, Ethernet (IEEE 802.3) adapters for wired data communications, and 802.11 adapters for wireless data communications. The communications adapter 114 of FIG. 1 is communicatively coupled to a wide area network 140 that also includes other computing devices, such as computing devices 141 and 142 as shown in FIG. 1.

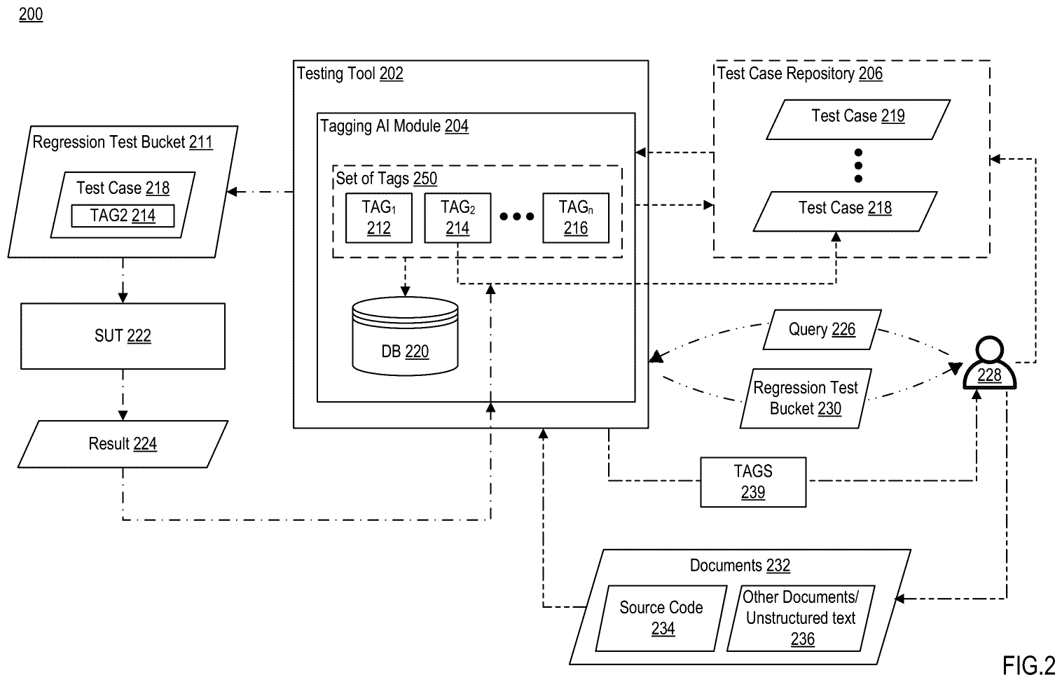

For further explanation, FIG. 2 sets forth a system 200 for generating referential artificial intelligence functionality for intuitively tagging infrastructure in accordance with at least one embodiment of the present disclosure. The example system 200 provides an illustrative implementation using a single tagged test case 218 as an example. It will be appreciated that system 200 is configured to tag any number of test cases and provide testing services based on those tagged test cases. The example system 200 includes a testing tool 202 configured for generating referential artificial intelligence functionality for intuitively tagging infrastructure. The testing tool 202 includes a tagging artificial intelligence (AI) module 204 that applies natural language processing based on a machine learning model to intelligently and automatically tag test cases with terms to describe the test case. The machine learning natural language processing (ML/NPL) framework is self-referential in that the tagging AI module 204 determines whether a tag that it has automatically generated for a test case is in fact descriptive of the test case based on observation of test case results and faults discovered by those test cases. The testing tool 202 also includes other aspects such as automated test application and analysis, automated test bucket generation, test case query and search, and so on. The system 200 includes a test case repository 206 including a collection of test cases such as test case 218 and test case 219. It will be understood that the test case repository 206 may include any number of test cases.

The example system 200 includes various operational flows represented by lines of different dash types, where lines of the same dash type illustrate a particular operational flow. In a first example aspect of operation, a user 228 submits a request to the testing tool 202 to analyze and tag test cases in the test case repository 206, and the test cases 218, 219 in the test case repository 206 are supplied to the tagging AI module 204 to generate a set of tags 250. The tagging AI module 204 automatically generates the set of tags 250 for tagging test cases in the test case repository 206 using the ML/NLP framework. Initially, a corpus or corpi is created from the test cases (and optionally other documents related to the test cases or a system under test (SUT) 222). The ML/NLP framework is then trained on these corpi. For example, natural language processing of a corpus can include removing stop words, stemming words, and generating a set of tokens based on words or phrases identified from the corpus. The tokens may be generated from descriptive text in the test case such as test case source code, an indication of a software system or code package that is tested by the test case, a native programming language, objectives of the test, a routine for carrying out the test, inputs for the test, expected outcomes of the test, use cases for the test, and so on. In some examples, tagging AI module 204 automatically generates the set of tags 250 by selecting a subset of the set of the tokens based on the frequency that those tokens appear in the corpus. In the example of FIG. 2, the set of tags 250 automatically generated from analysis of the corpus includes TAG₁ 212, TAG₂ 214 . . . . TAGₙ 216.

In one example, the tagging AI module 204 generates a relevancy score for tokens parsed from each test case in the collection of test cases. The relevancy scores are generated based on the frequency that those tokens appear in the corpus. For example, when the ML/NLP is trained on the test cases as a focused corpus, the ML/NLP may determine that certain words that rarely appear in general language are overused in the language of the test cases. Such overfitting words, as reflected by the relevancy scores, may have diminished value for tagging a test case. The tagging AI module 204 selects tokens based on the relevancy scores by identifying tokens that should be kept or discarded as tags based on the frequency that the tokens appear in the corpus as a whole. For example, the tagging AI module 204 may apply a set of rules to remove overfitting or underfitting tokens.

Continuing the first example aspect of operation, the testing tool tags test cases (e.g., test cases 218, 219) based on the set of automatically generated tags 250. Each test case is input to the testing tool 202, which parses and tokenizes the test case and determines whether the test case includes any tokens that correspond to any tags in the set of tags 250. When the test case includes a term that matches to a particular tag in the set of tags 250, the test case is tagged with that particular tag. In the example of FIG. 2, the testing tool 202 determines that test case 218 includes a term corresponding to TAG₂ 214, and thus the testing tool 202 tags test case 218 with TAG₂ 214. The tagging may be carried out by adding the tag within the test case using a tag notation, by associating the test case with the tag in a database, or through any similar means. For example, an association between test 218 and TAG₂ 214 is written to a database 220.

In a second example aspect of operation, the tagged test case 218 is included in a regression test bucket 211. The testing tool 202 runs the tagged test case 218 on a system under test (SUT) 222. The result 224 of the testing is analyzed by the tagging AI module 204, which may use the result to validate or harden an automatically generated tag associated with the test case 218. For example, the tagging AI module 204 determines whether the result 224 of the testing identifies a fault related to one of the automatically generated tags of the test case. Determining the relationship between the fault and the tag may be carried out by identifying the particular component or function that caused the fault and comparing the faulting component or function to the automatically generated tags associated with the test case 218. For example, if the test case caused a failure in the SUT 222 while executing a subcomponent called ‘Module1,’ the tagging AI module 204 determines that a tag ‘Module1’ associated with the test case 218 is related to the fault identified while running the test case. To aid illustration, assume that TAG₂ 214 is ‘Module1’ and is related to a fault in the SUT 222 discovered by test case 218 and indicated in the result 224. The tagging AI module 204 validates TAG₂ 214 by hardening the association between test case 218 and TAG₂ 214.

A test case may be associated with two classifications of tags: hard tags and automatically generated tags. The hard tags include those that are known to be true including those that were manually added by a human developer, test designer, or test engineer. The automatically generated tags are tags that were generated and added through the ML/NLP framework. When a test case causes a failure and that failure is related to an automatically generated tag, the automatically generated tag is a valid or true tag for the test case. Thus, the tagging AI module 204 may change the classification of TAG₂ 214 to a hard tag or add TAG₂ 214 to a list of hard tags for the test case 218 maintained in, for example, database 220. In other examples, tagging AI module 204 increases the weight of the association between TAG₂ 214 and the test case 218, increases a relevance score of the TAG₂ 214 in relation to the test case 218, and uses other such techniques to differentiate a validated automatically generated tag from other unvalidated automatically generated tags for the test case 218.

In a third example aspect of operation, the testing tool 202 receives a query 226 from a user 228 that includes search criteria to find test cases related to the search criteria. The 202 matches the search criteria to tags in the set of tags 250 and retrieves a set of test cases that include those tags. The testing tool 202 then, in response, indicates the matching test cases to the user and/or automatically populates a regression test bucket 230 with all the tagged test cases that match the search criteria based on the tags. In the example of FIG. 2, the search criteria of the query 226 may match to TAG₂ 214. The testing tool 202 may then populate a regression test bucket 230 with test case 218 that is tagged with TAG₂ 214 as well as other matching test cases.

In a fourth example aspect of operation, the tagging AI module 204 analyzes documents 232 that are provided by a user 228 and related to, for example, a system update. For example, the source code 234 of the system update may be stored in a code repository or development utility along with other documents/unstructured text 236 such as specifications, developer postings or chats, a ‘readme’,’ and so on. The tagging AI module 204 applies the ML/NPL framework to analyze the text of the supplied documents 232 and generates a set of tags 239 based on the documents 232. This set of tags 239 can be provided to the user 228, who can use the set of tags 239 to query the testing tool 202 for tagged test cases related to the set of tags 239 generated from the documents 232. Thus, the user 228 can easily populate a regression bucket with test cases relevant to a system update. For example, TAG₂ 214 may be included in the set of tags 239 generated for the documents 232. When the user supplies TAG₂ 214 as a query to the testing tool 202, the testing tool matches the tag to test case 218. The testing tool 202 may then indicate that test case 218 is a relevant test case for the system update or may populate a regression test bucket with test case 218.

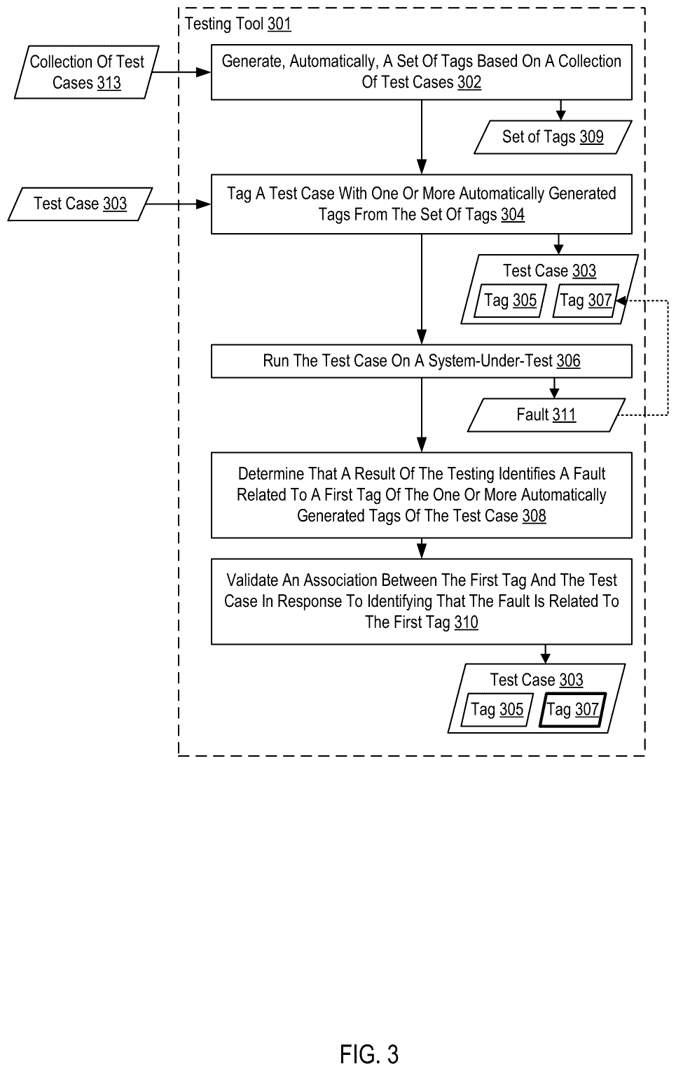

For further explanation, FIG. 3 sets forth a flow chart of an example method for generating referential artificial intelligence functionality for intuitively tagging infrastructure in accordance with at least one embodiment of the present disclosure. The method of FIG. 3 includes generating 302, automatically, a set 309 of tags based on a collection 313 of test cases. In some examples, a tagging AI module of a testing tool 301 automatically generates 302 a set 309 of tags for tagging test cases based on the collection 313 of test cases in a test case repository using a machine-learning natural language processing (ML/NLP) framework. For example, the ML/NLP framework may be trained on a corpus or corpi that is generated from the collection 313 of test cases and, in some cases, documents related to the test cases. Natural language processing of the test cases can include removing stop words, stemming words, and generating a set of tokens based on words or phrases identified from the test cases. The tokens may be generated from descriptive text such as test case source code, an indication of a software system or code package that is tested by a test case, a native programming language, objectives of a test, a routine for carrying out the test, inputs for the test, expected outcomes of the test, use cases for the test, and so on. In some examples, the testing tool 301 automatically generates 302 the set 309 of tags by selecting a subset of the set of the tokens based on the frequency that those tokens appear in the collection 313 of test cases. The selection of tokens as tags based on the frequency of those tokens will be described in more detail below.

In some implementations, the collection 313 of test cases includes all test cases written for testing a particular SUT, such as an application or operating system. In other implementations, the collection 313 of test cases includes all test cases written for testing a particular module or code package (e.g., a driver, a memory management system, a graphics engine, etc.) within the SUT. The set 309 of tags that are automatically generated from the collection 313 of test cases, through the ML/NLP framework, represents the set of tags used to tag each test case in the collection 313 of test cases.

In a particular implementation, the collection 313 of test cases includes all of the test cases in a particular set of regression test buckets. For example, before tagging test cases a particular regression test bucket, the testing tool 301 generates a set of tags through machine-learning natural language processing of the test cases in the regression test buckets that reference the test case. Thus, the set of tags that are automatically generated through machine-learning natural language processing of the regression test buckets represents the set of tags that are used to tag each test case in the regression test buckets. When tagging test case 303 from the regression bucket, the testing tool 301 selects tags from the set of tags that were automatically generated for the regression test bucket.

In a simplified implementation, the testing tool 301 automatically generates 302 the set 309 of tags for the test case itself. That is, the set 309 of tags for tagging the test case 303 are derived from NLP of the test case 303 by itself rather than a collection of test cases. For example, the test case 303 may be a new test case for new module or code package, or it may be desirable to generate tags ‘on-the-fly’ without prior NLP analysis of related test cases. In such an implementation, the tagging AI module of a testing tool 301 ingests the test case 303 and applies the ML/NLP framework to text in the test case 303 as described above. In some examples, the testing tool 301 automatically generates 302 a set of tags by selecting a subset of the set of the tokens based on the frequency that those tokens appear in the test case 303.

The method of FIG. 3 also includes tagging 304 a test case 303 with one or more automatically generated tags 305, 307 from the set 309 of tags. In some examples, the testing tool 301 tags 304 the test case 303 with one or more automatically generated tags 305, 307 by identifying which tags 305, 307 among the set of 309 tags match to the content of the test case 303. For example, the testing tool 301 may perform NLP on the test case 303 to tokenize the text in the test case and compare the tokens in the test case to tags in the set 309 of tags. The testing tool 301 then tags 304 the test case 303 by associating the identified tags 305, 307 with the test case 303. For example, the testing tool 301 can associate the tags 305, 307 by adding the tags as special text in the test case 303, associating the test case 303 with the tags 305, 307 in a database, adding the tags 305, 307 as file or object descriptors to a test case file, and so on.

The set of automatically generated tags may relate to attributes of the test case including component or functions tested by the test case. To aid illustration, a training of the tagging AI module may produce a set of tags that include the tag ‘Module1’ related to a software component or code package called Module1, the tag ‘I/O’ related to I/O functions, and the tag ‘networking’ related to networking functions. A test case that refers to ‘Module1’ will be tagged with the ‘Module1’ tag. A test case that is directed to or includes I/O functions will be tagged with the ‘I/O’ tag. A test case that is directed to or includes networking functions will be tagged with the ‘networking’ tag. The mention of a component or description of a function tested may be determined through NLP analysis of the test case.

The method of FIG. 3 also includes running 306 the test case 303 on a system-under-test (SUT). In some examples, the testing tool 301 runs 306 the test case 303 on the SUT by automatically applying one or more inputs specified in the test case 303 to the SUT and comparing an output or result to one or more expected outcomes specified in the test case. In running 306 the test case 303, the testing tool 301 also identifies any errors or exceptions generated as a result of executing the test case by analyzing error logs, system logs, or debug logs.

The method of FIG. 3 also includes determining 308 that a result of the testing identifies a fault 311 related to a first tag 307 of the one or more automatically generated tags 305, 307 of the test case 303. In some examples, the testing tool 301 determines 308 that a result of the testing identifies a fault related to a first tag 307 by identifying the particular component or function that caused the fault and comparing the faulting component or function to the automatically generated tags 305, 307 associated with the test case 303. For example, if the test case caused a failure in the SUT while executing a subcomponent called ‘Module1,’ the testing tool 301 determines that a tag ‘Module1’ associated with the test case 303 is related to the fault identified while running the test case. As another example, if the test case caused an input/output failure in the SUT, the testing tool 301 determines that an ‘I/O’ tag associated with the test case 303 is related to the fault identified while running the test case. This may indicate a fault in an I/O driver of the SUT. In yet another example, if the test case reveals that the SUT is unable to connect to a network, the testing tool 301 determines that an ‘networking’ tag associated with the test case 303 is related to the fault identified while running the test case. This may indicate a fault in a network adapter of the SUT.

The method of FIG. 3 also includes validating 310 an association between the first tag 307 and the test case 303 in response to identifying that the fault 311 is related to the particular tag 307. As previously discussed, a test case 303 is associated with two classifications of tags: hard tags and automatically generated tags. The hard tags include those that are known to be true including those that were manually added by a human developer, test designer, or test engineer. The automatically generated tags are tags that were generated and added through the ML/NLP framework. When a test case causes a failure and that failure is related to an automatically generated tag, the automatically generated tag is a valid or true tag for the test case. In some examples, the testing tool 301 validates 310 the association between the first tag 307 and the test case 303 in response to identifying that the fault 311 related to the particular tag 307 by promoting the tag 307 to a hard tag. For example, the testing tool 301 may change the classification of the automatically generated tag 307 to a hard tag or add the automatically generated tag to a list of hard tags for the test case 303. In other examples, the testing tool 301 validates 310 the association between the tag 307 and the test case by increasing the weight of the association between the tag 307 and the test case 303, increasing a relevance score of the tag 307 in relation to the test case 303, and by other such techniques that differentiate a validated automatically generated tag from other unvalidated automatically generated tags for the test case 303.

It will be appreciated that, in view of the foregoing, the self-referential artificial intelligence of the tagging AI module may identify tags for a test case that might otherwise not been associated with a test case. For example, it might not be understood by a human that a particular test case is applicable to testing an I/O function or a networking function, and thus such tags would not be included by the human. However, the tagging AI module may identify such associations based on a ML/NLP analysis of language used in the test case. Further, given a very large library of tests, it might not be possible for humans to retroactively add tags to test cases. Still further, as the tagging AI module promotes automatically generated tags to hard tags based on identifying a fault, and removes unvalidated automatically generated tags that are never correlated to a fault, the resulting set of tags associated with a test case will eventually only include tags that are hard tags. Thus, each tag associated with a test case will indicate a particular component or function for which the test case has demonstrated its ability to detect an error.

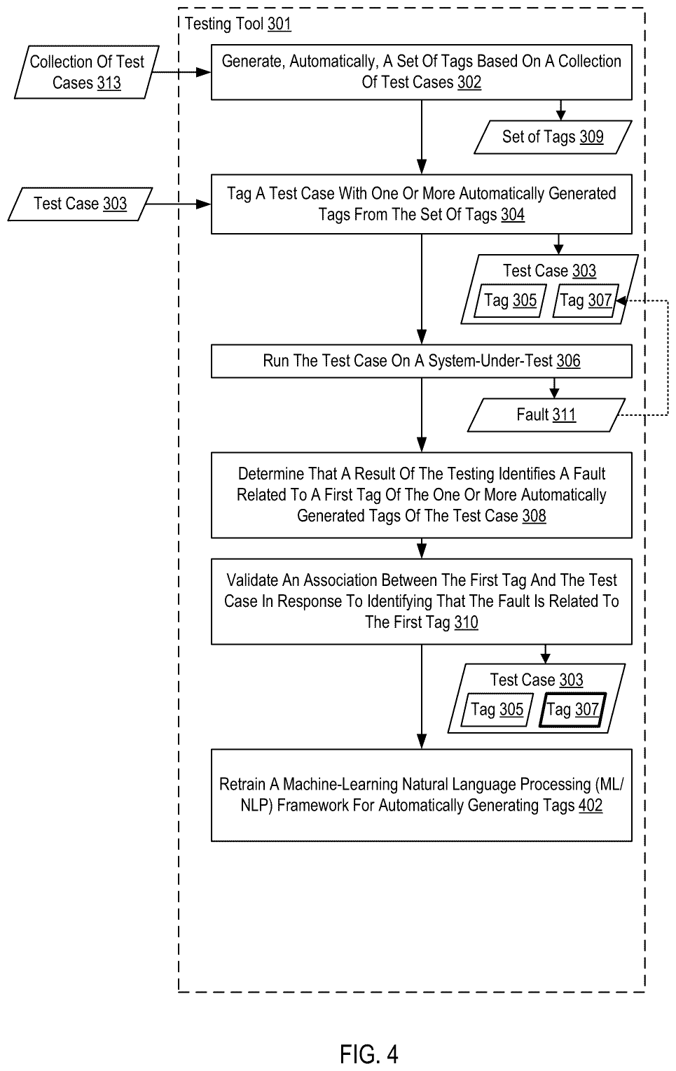

For further explanation, FIG. 4 sets forth a flowchart illustrating an example method of generating referential artificial intelligence functionality for intuitively tagging infrastructure according to embodiments of the present disclosure. The method of FIG. 4 continues with the method of FIG. 3 by further including retraining 402 the ML/NLP framework for automatically generating tags. In some examples, the testing tool 301 retrains 402 the ML/NLP framework of the tagging AI module based on a different or modified collection of test cases. For example, new test cases may be added to the collection of test cases or cases may be removed from the collection of test cases. One example where a test case is removed is when the test case has a low success rate, where success is defined by the ability of the test case to elicit a fault. As test cases are removed from the collection of test cases, the set 309 of tags is also modified, which may result in a tag 305 being removed from the set 309 of tags. In such examples, the testing tool 301 may remove 402 a tag 305 from the test case 303 when the tag 305 is removed from the set of tags.

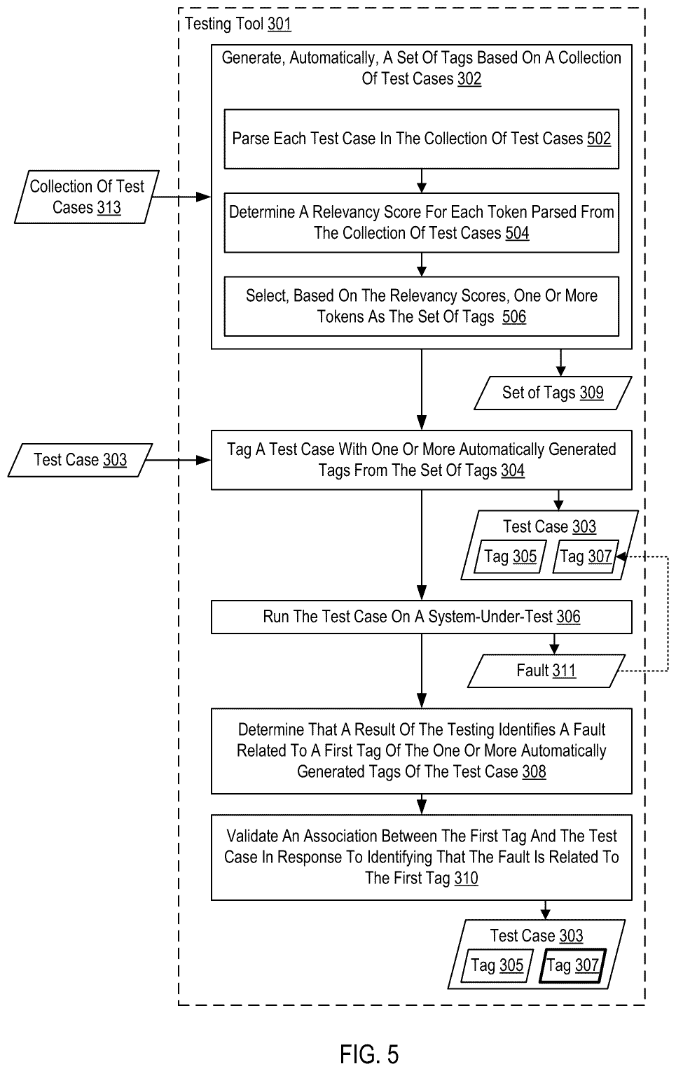

For further explanation, FIG. 5 sets forth a flowchart illustrating an example method of generating referential artificial intelligence functionality for intuitively tagging infrastructure according to embodiments of the present disclosure. The method of FIG. 5 continues with the method of FIG. 3 by further including parsing 502 each test case in the collection 313 of test cases as part of generating 302, automatically, a set 309 of tags based on a collection 313 of test cases. In some examples, the testing tool 301 trains the ML/NLP framework of the tagging AI module based on tokens parsed 502 from each test case in the collection 313 of test cases. The test cases provide a focused corpus for a more accurate language model rather than using a general language model. For example, there may be a collection of test cases for a particular operating system subsystem. Thus, this collection provides a focused corpus for training the ML/NLP framework.

The method of FIG. 5 also includes determining 504 a relevancy score for each token parsed from the collection 313 of test cases as part of generating 302, automatically, a set 309 of tags based on a collection 313 of test cases. In some examples, the testing tool 301 determines the 504 the relevancy scores using NLP based on the frequency that those tokens appear in the collection of test cases. For example, when the ML/NLP is trained on the test cases in the collection 313 of test cases as a focused corpus, the ML/NLP may determine that certain words that rarely appear in general language are overused in the language of the test cases. Such overfitting words, as reflected in the histogram, may have diminished value for tagging a test case.

The method of FIG. 5 also includes selecting 506, based on the relevancy scores, the set 309 of tags. In some examples, the testing tool 301 selects 506 the set 309 of tags from the tokens identifying tokens that should be kept or discarded as tags based on the relevancy scores. For example, the testing tool 301 may apply a set of rules to the relevancy scores. To aid illustration, in one example, the bottom 25% of tokens by rank (i.e., the 75^{th} to 100^{th} percentile of token frequency) might be discarded as underfitting for potential tags. These tokens may be too general and may not be useful in predicting tags that describe a particular test case. Also, the top 5% of tokens by rank (i.e., the 0 to 5th percentile of token frequency) might be discarded as overfitting for potential tags. These tokens may be too specific and may not be applicable to very many test cases. Typically, as tokens become less in count, they become less valuable for tagging. However, when a token appears only a few times (e.g., a hapax, dis, tris, or tetrakis legomenon), that token may be uniquely descriptive for a particular test case. Although appearing to be overfitting, such terms return to being very accurate at tagging since they were chosen specifically for that test case.

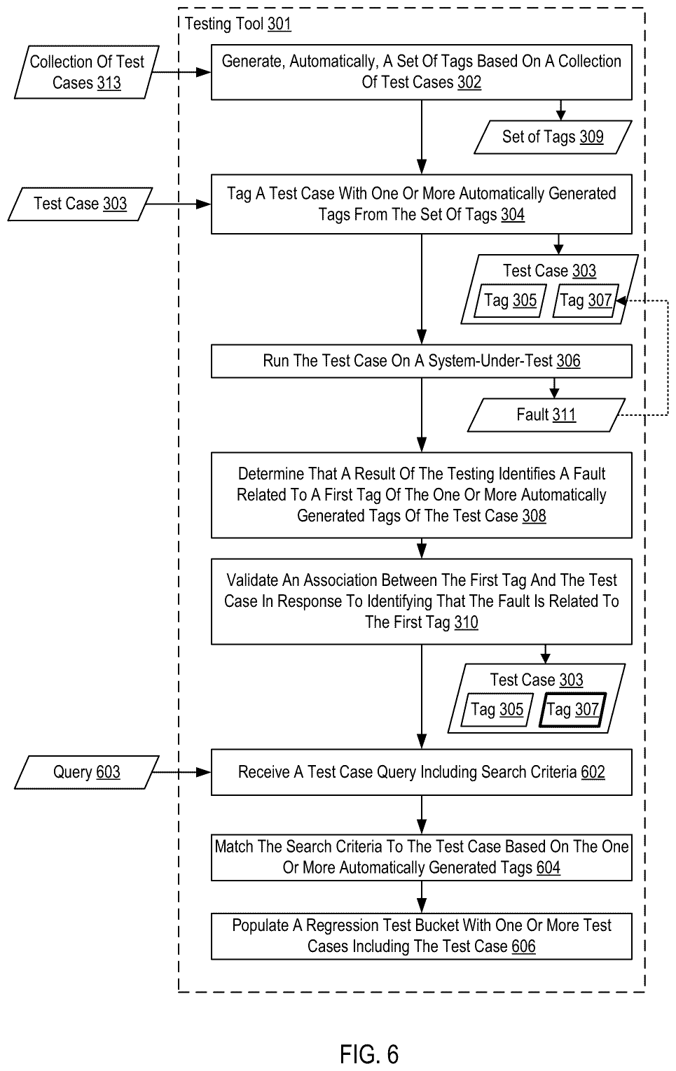

For further explanation, FIG. 6 sets forth a flowchart illustrating an example method of generating referential artificial intelligence functionality for intuitively tagging infrastructure according to embodiments of the present disclosure. The method of FIG. 6 continues with the method of FIG. 3 by further including receiving 602 a test case query 603 including search criteria. As previously discussed, a tagged test case may be stored in a database of tagged test cases. The tags may be embodied in the test case itself or associated with the test case through the database. In some examples, the testing tool 301 receives a test case query 603 containing search criteria from a user. For example, the test case query 603 may include search criteria such as key words describing the test cases the user is looking for. In one example, the search criteria may include specific tags corresponding to tags in sets of automatically generated tags.

The method of FIG. 6 also includes matching 604 the search criteria to the test 303 case based on the one or more automatically generated tags 305, 307. In some examples, the testing tool 301 matches 604 the search criteria to the test case 303 by identifying which tags generated or known by the testing tool 301 correspond to the search criteria. The testing tool 301 then determines which test cases in the database of test cases include the identified tags. For example, the user may submit a query for tests cases including search criteria that specifies the I/O function of a particular operating system subsystem, where the operating system subsystem includes Module1. The testing tool 301 may identify that ‘I/O’ and ‘Module1’ are tags relevant to the query. The testing tool 301 also identifies test case 303 as being tagged with ‘I/O’ and ‘Module1.’ Thus, the query is matched to the test case 303.

The method of FIG. 6 also includes populating 606 a regression test bucket with one or more test cases including the test case 303. In some examples, the testing tool 301 populates 606 a regression bucket by automatically generating a regression bucket that includes all test cases (or some specified number of highest-ranking test cases) that are tagged with tags that match to the search criteria. For example, as described above, the testing tool 301 matches the search criteria to test case 303 based on the tags of the test case. The testing tool 301 also matches the search criteria to other test cases based on the tags of those test cases. The collection of test cases that include at least one tag that matches to the search criteria form the regression test bucket. In some examples, the test cases in the regression test bucket are ranked based on relevance to the query. Where the user specifies a maximum number of results, the testing tool 301 may trim the regression test bucket to include only the highest-ranking test cases up to the maximum number of results.

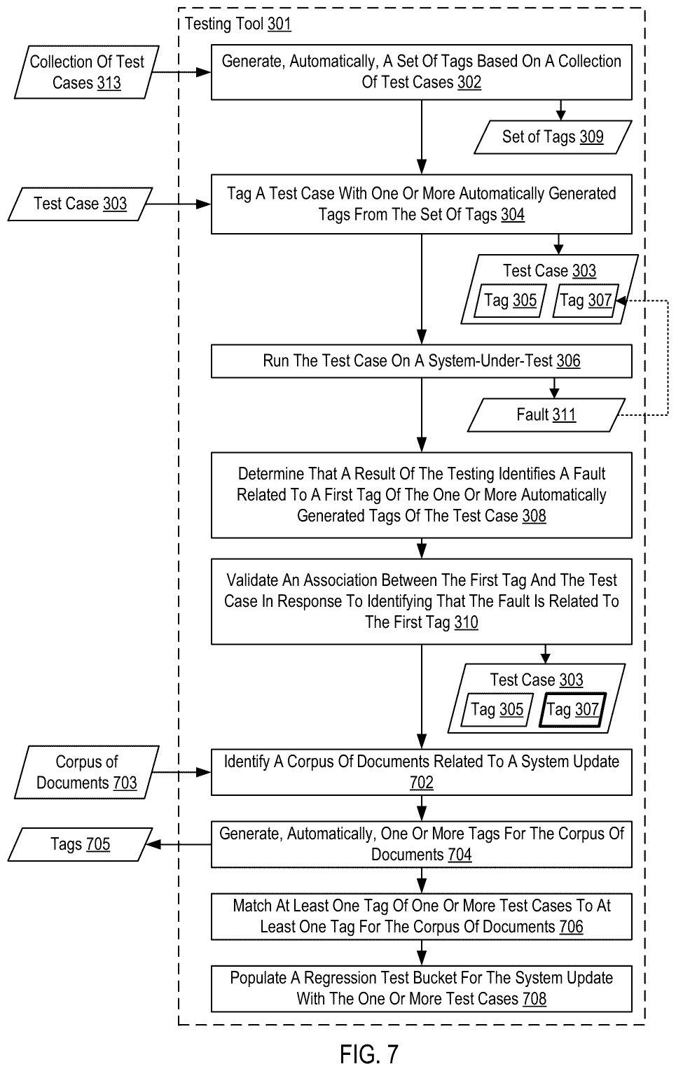

For further explanation, FIG. 7 sets forth a flowchart illustrating an example method of generating referential artificial intelligence functionality for intuitively tagging infrastructure according to embodiments of the present disclosure. The method of FIG. 7 continues with the method of FIG. 3 by further including identifying 702 a corpus 703 of documents related to a system update. The system update may be, for example, an update to a module, an addition of a module, and so on. The system update may be, for example, included or described in a code repository such as Github or a project management tool such as Maven. In some examples, the testing tool 301 identifies 702 a corpus 703 of documents related to a system update by retrieving documents that describe the system update from sources related to the system update such as code repositories or project management sites. For example, the documents can include manuals, ‘READMEs’, specifications, developer comments, and other text related to the system update as well as the source code itself including both the comments and the code.

The method of FIG. 7 also includes generating 704, automatically, one or more tags 705 for the corpus 703 of documents. In some examples, the testing tool 301 automatically generates 704 the one or more tags 705 for the corpus 703 of documents by applying the ML/NPL framework to the corpus 703 of documents. As discussed above with respect to the collection 313 of test cases, the documents in the corpus 703 of documents are parsed and tokenized, and relevancy scores are generated based on the frequency of the tokens in the documents. The tagging AI module, utilizing the ML/NPL framework, generates one or more tags 705 for the documents based on the relevancy scores. To aid illustration, consider an example where the system update is an update to Module1 of an operating system that relates to I/O functionality. The testing tool 301 identifies documents related to the update to Module1 from a code repository. The documents from the code repository include, for example, the commented source code, project specification, developer notes, and developer comments. Based on the ML/NPL analysis of these documents, the tagging AI module of the testing tool 301 identifies that a set of tags for the system update includes ‘Module1’ and ‘I/O’ among other tags. For example, ‘Module1’ may appear a significant number of times in the comments of the source code for ‘Module1’ or may be discussed heavily in developer comments or chat, and so on. In some examples, the tags 705 for the corpus of documents are returned to a user. The user can then supply those tags to the testing tool 301 to identify relevant test cases in a tagged test case database. In other examples, the tags 705 from the corpus of document are used to automatically identify relevant cases in a tagged test case database.

The method of FIG. 7 also includes matching 706 at least one tag 307 of one or more test cases to at least one tag 705 for the corpus 703 of documents. In some examples, the testing tool 301 matches 706 at least one tag 307 of a test case 303 to at least one tag 705 by searching the database of tagged test cases for test cases having a tag 307 corresponding to a tag 705 associated with the corpus 703 of documents. Continuing the above example, the testing tool 301 identifies the tag ‘Module1’ as associated with the corpus of documents and thus is associated with the system update. The testing tool 301 then searches the database of test cases and determines that, among other, the above-described test case 303 includes the tag ‘Module1.’ Thus, the testing tool 301 matches test case 303 (among others) to a tag for the corpus of documents and thus to the system update.

The method of FIG. 7 also includes populating 708 a regression test bucket for the system update with the one or more test cases. In some examples, the testing tool 301 populates 708 a regression test bucket by automatically generating a regression bucket that includes all test cases (or some specified number of highest-ranking test cases) that are tagged with tags that match tags of the corpus of documents for the system update. Thus, the testing tool 301 automatically generates a regression test bucket with test cases that are relevant to the system update based on an analysis of tags that are automatically generated for the test cases and tags that are automatically generated for the system update based on documentation of the system update. In other examples, the testing tool 301 populates 708 the regression test bucket based on a query from a user that includes tags identified from the corpus of documents.

In view of the explanations set forth above, readers will recognize that the benefits of generating referential artificial intelligence functionality for intuitively tagging infrastructure according to embodiments of the present disclosure include:
Providing intuitive tagging of test cases based on automatically generated tags, such that large volumes of test cases may be tagged without human effort.
Increasing the accuracy of automatically generated tags by validating those tags based on real-world outcomes.
Automatically generating or populating test buckets based on tags that match to a user query or tags that match to other tagged documents related to a development stream.

Exemplary embodiments of the present disclosure are described largely in the context of a fully functional computer system for optimizing network load in multicast communications. Readers of skill in the art will recognize, however, that the present disclosure also may be embodied in a computer program product disposed upon computer readable storage media for use with any suitable data processing system. Such computer readable storage media may be any storage medium for machine-readable information, including magnetic media, optical media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps of the method of the disclosure as embodied in a computer program product. Persons skilled in the art will recognize also that, although some of the exemplary embodiments described in this specification are oriented to software installed and executing on computer hardware, nevertheless, alternative embodiments implemented as firmware or as hardware are well within the scope of the present disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be understood from the foregoing description that modifications and changes may be made in various embodiments of the present disclosure without departing from its true spirit. The descriptions in this specification are for purposes of illustration only and are not to be construed in a limiting sense. The scope of the present disclosure is limited only by the language of the following claims.

What is claimed is:

1. A method comprising:
generating, automatically, a set of tags based on a collection of test cases;
tagging a test case with one or more automatically generated tags from the set of tags;
running the test case on a system-under-test (SUT);
determining that a result of the testing identifies a fault related to a first tag of the one or more automatically generated tags of the test case; and
validating an association between the first tag and the test case in response to identifying that the fault is related to the first tag.

2. The method of claim 1, wherein the first tag is validated by hardening the first tag for the test case.

3. The method of claim 1, wherein the set of tags is automatically generated through a machine-learning natural language processing (ML/NLP) framework.

4. The method of claim 3 further comprising:
retraining the ML/NLP framework.

5. The method of claim 1, wherein generating, automatically, a set of tags based on a collection of test cases includes:
parsing each test case in the collection of test cases;
determining a relevancy score for each token parsed from the collection of test cases; and
selecting, based on the relevancy scores, one or more tokens as the set of tags.

6. The method of claim 1 further comprising:
receiving a test case query including search criteria;
matching the search criteria to the test case based on the one or more automatically generated tags; and
populating a regression test bucket with one or more test cases including the test case.

7. The method of claim 1 further comprising:
identifying a corpus of documents related to a system update;
generating, automatically, one or more tags for the corpus of documents; and
matching at least one tag of one or more test cases to at least one tag for the corpus of documents.

8. An apparatus for generating referential artificial intelligence functionality for intuitively tagging infrastructure, the apparatus comprising a computer processor, a computer memory operatively coupled to the computer processor, the computer memory having disposed therein computer program instructions that, when executed by the computer processor, cause the apparatus to carry out the steps of:
generating, automatically, a set of tags based on a collection of test cases;
tagging a test case with one or more automatically generated tags from the set of tags;
running the test case on a system-under-test (SUT);
determining that a result of the testing identifies a fault related to a first tag of the one or more automatically generated tags of the test case; and
validating an association between the first tag and the test case in response to identifying that the fault is related to the first tag.

9. The apparatus of claim 8, wherein the first tag is validated by hardening the first tag for the test case.

10. The apparatus of claim 8, wherein the set of tags is automatically generated through a machine-learning natural language processing (ML/NLP) framework.

11. The apparatus of claim 10 further comprising computer program instructions that, when executed by the computer processor, cause the apparatus to carry out the steps of:
retraining the ML/NLP framework.

12. The apparatus of claim 8, wherein generating, automatically, a set of tags based on a collection of test cases includes:
parsing each test case in the collection of test cases;
determining a relevancy score for each token parsed from the collection of test cases; and
selecting, based on the relevancy scores, one or more tokens as the set of tags.

13. The apparatus of claim 8 further comprising computer program instructions that, when executed by the computer processor, cause the apparatus to carry out the steps of:
receiving a test case query including search criteria;
matching the search criteria to the test case based on the one or more automatically generated tags; and
populating a regression test bucket with one or more test cases including the test case.

14. The apparatus of claim 8 further comprising computer program instructions that, when executed by the computer processor, cause the apparatus to carry out the steps of:
identifying a corpus of documents related to a system update;
generating, automatically, one or more tags for the corpus of documents; and
matching at least one tag of one or more test cases to at least one tag for the corpus of documents.

15. A computer program product for generating referential artificial intelligence functionality for intuitively tagging infrastructure, the computer program product disposed upon a computer readable medium, the computer program product comprising computer program instructions that, when executed, cause a computer to carry out the steps of:
generating, automatically, a set of tags based on a collection of test cases;
tagging a test case with one or more automatically generated tags from the set of tags;
running the test case on a system-under-test;
determining that a result of the testing identifies a fault related to a first tag of the one or more automatically generated tags of the test case; and
validating an association between the first tag and the test case in response to identifying that the fault is related to the first tag.

16. The computer program product of claim 15, wherein the first tag is validated by hardening the first tag for the test case.

17. The computer program product of claim 15, wherein the set of tags is automatically generated through a machine-learning natural language processing (ML/NLP) framework.

18. The computer program product of claim 17 further comprising computer program instructions that, when executed, cause the computer to carry out the steps of:
retraining the ML/NLP framework.

19. The computer program product of claim 15 further comprising computer program instructions that, when executed, cause the computer to carry out the steps of:
parsing each test case in the collection of test cases;
determining a relevancy score for each token parsed from the collection of test cases; and
selecting, based on the relevancy scores, one or more tokens as the set of tags.

20. The computer program product of claim 15 further comprising computer program instructions that, when executed, cause the computer to carry out the steps of:
identifying a corpus of documents related to a system update;
generating, automatically, one or more tags for the corpus of documents; and
matching at least one tag of one or more test cases to at least one tag for the corpus of documents.
